(19) United States
(12) Patent Application Publication
(10) Pub. No.: US 2016/0075899 A1
(43) Pub. Date: Mar. 17, 2016

(54) IMAGE RECORDING METHOD AND INK SET

(71) Applicant: CANON KABUSHIKI KAISHA, Tokyo (JP)

(72) Inventors: Takashi Imai, Kawasaki-shi (JP); Mamiko Kaji, Kawasaki-shi (JP); Shinichi Sakurada, Tokyo (JP)

(21) Appl. No.: 14/836,176

(22) Filed: Aug. 26, 2015

(30) Foreign Application Priority Data
Sep. 17, 2014 (JP) 2014-188876

(51) Int. Cl. C09D 11/54; C09D 11/03; C09D 11/107

(52) U.S. Cl. CPC C09D 11/54; C09D 11/107; C09D 11/03

(57) ABSTRACT

Provided is an image recording method including a step (A) of applying an ink to a recording medium, a step (B) of applying to the recording medium a liquid composition that causes viscosity increase when mixed with the ink, and a step (C) of applying a clear ink. The clear ink contains an anionic water-soluble resin and at least one surfactant selected from fluorine-based surfactants and silicone-based surfactants; the content of the surfactant in the clear ink is 1% by mass or more and 8% by mass or less based on the total mass of the ink; and the mass ratio of the content of the water-soluble resin to the content of the surfactant in the clear ink is 0.3 times or more and 10.0 times or less.

### BACKGROUND OF THE INVENTION

1. Field of the Invention

The present invention relates to an image recording method and an ink set.

2. Description of the Related Art

In conventional ink jet image recording methods, a two-liquid reaction system including an ink and a liquid composition containing a reactant that causes an increase in viscosity of the ink when coming in contact with the ink has been studied (Japanese Patent Application Laid-Open No. 2010-31267).

In the ink jet image recording methods, a system of applying a clear ink on an image has been also studied. Japanese Patent Application Laid-Open No. 2004-181803 and Japanese Patent Application Laid-Open No. 2011-252118 disclose image recording methods using a clear ink containing a resin and teach that these image recording methods can give images with good glossiness and the like.

### SUMMARY OF THE INVENTION

According to an aspect of the present invention, an image recording method includes a step (A) of applying an ink containing a coloring material to a recording medium, a step (B) of applying a liquid composition to the recording medium so as to at least partially overlap with an area where the ink is applied, the liquid composition causing viscosity increase when mixed with the ink, and a step (C) of applying a clear ink containing no coloring material to the recording medium so as to at least partially overlap with an area where the liquid composition is applied. In the image recording method, the clear ink contains an anionic water-soluble resin and at least one surfactant selected from fluorine-based surfactants and silicone-based surfactants, the content of the surfactant in the clear ink is 1% by mass or more and 8% by mass or less based on the total mass of the clear ink, and the mass ratio of the content of the water-soluble resin to the content of the surfactant in the clear ink is 0.3 times or more and 10.0 times or less.

Further features of the present invention will become apparent from the following description of exemplary embodiments.

### DESCRIPTION OF THE EMBODIMENTS

The inventors of the present invention have tried an image recording method of applying a clear ink onto an image formed by the above-mentioned two-liquid reaction system. However, according to the studies by the inventors, when the image recording method is used to record images, smeared images and image cracks are generated on some images, and a high-quality image cannot be recorded in some cases.

The present invention is directed to providing an image recording method that enables recording of images with less smeared images or image cracks and with good glossiness even when images are recorded by the image recording method combining the two-liquid reaction system and a clear ink.

The present invention will now be described in detail with reference to preferred embodiments. In the below description, “(meth)acrylic acid” and “(meth)acrylate” mean “acrylic acid, methacrylic acid” and “acrylate, methacrylate”, respectively.

The inventors of the present invention have first studied the reason why smeared images and image cracks are generated on images and high-quality images cannot be recorded when the images are recorded by the image recording method of applying an ink, a liquid composition that causes viscosity increase when mixed with the ink, and a clear ink. The results will be described below.

The clear ink is an ink that is applied in order to give gloss to images. To achieve this purpose, a water-soluble resin is used as a resin component so as to be hard to generate unevenness on the image surface. In addition, when a clear ink is further applied in the image recording method (two-liquid reaction system) using the liquid composition, the reactivity between the clear ink and the liquid composition has to be designed to be high in order to effectively suppress image bleeding or smeared images. Specifically, the clear ink and the liquid composition are formulated so that the water-soluble resin immediately aggregates on a recording medium when the clear ink comes in contact with the liquid composition.

However, when images are recorded by the above-mentioned image recording method, image cracks are generated on some images. This is supposed to be because the water-soluble resin in the clear ink reacts with the liquid composition to cause volumetric shrinkage and moves within the area where the clear ink has been applied. The inventors of the present invention have studied a method for suppressing the image cracks in the image recording method. As a result, the inventors have found that the image cracks can be effectively suppressed by using a clear ink that contains an anionic water-soluble resin and a surfactant such as fluorine-based surfactants within particular content and mass ratio ranges, and have arrived at the configuration of the present invention. Specifically, the image recording method of the present invention is characterized by using a clear ink satisfying the following requirements (1) to (3).

(1) Containing an anionic water-soluble resin and at least one surfactant selected from fluorine-based surfactants and silicone-based surfactants.

(2) The content of the surfactant in the clear ink being 1% by mass or more and 8% by mass or less based on the total mass of the clear ink.

(3) The mass ratio of the content of the water-soluble resin to the content of the surfactant in the clear ink being 0.3 times or more and 10.0 times or less.

Mechanisms of producing the advantageous effect of the present invention with the configuration will be described below.

The inventors of the present invention have thought that the volumetric shrinkage ratio of the water-soluble resin is required to be reduced when the water-soluble resin in the clear ink reacts with the liquid composition in order to suppress image bleeding and smeared images and also to suppress image cracks.

The inventors have thus further carried out intensive studies, and consequently have found that both the suppression of image bleeding and smeared images and the suppression of image cracks can be achieved by combined use of an anionic water-soluble resin with a particular surfactant such as fluorine-based surfactants at a particular ratio. This is supposed to be achieved by coexistence of an anionic water-soluble resin that exhibits viscosity increase action when coming in contact with a liquid composition and the surfactant that has a weak interaction with the water-soluble resin and is likely to be incorporated in aggregates of the water-soluble resin, at a particular ratio. In this manner, it is supposed that both the suppression of image bleeding and smeared images and the suppression of image cracks can be achieved and high glossiness can be provided.

If the content of the surfactant is less than 1% by mass in the clear ink, the volumetric shrinkage of the water-soluble resin cannot be sufficiently suppressed, and image cracks occur.

If the mass ratio of the content of the water-soluble resin to the content of the surfactant is less than 0.3 times ([the content of the water-soluble resin]/[the content of the surfactant]<0.3), the water-soluble resin insufficiently produces the effect of suppressing the volumetric shrinkage, and image cracks occur.

If the mass ratio of the content of the water-soluble resin to the content of the surfactant is more than 10 times ([the content of the water-soluble resin]/[the content of the surfactant]>10), the water-soluble resin is difficult to aggregate even when coming in contact with the liquid composition, and smeared images occur.

The image recording method and the ink set of the present invention will next be described.

Image Recording Method

The image recording method of the present invention includes a step (A) of applying an ink to a recording medium, a step (B) of applying a liquid composition that causes viscosity increase when mixed with the ink, to the recording medium, and a step (C) of applying a clear ink to the recording medium.

In the present invention, the step (A), the step (B), and the step (C) can be performed in any order. For example, after the step (A), the step (B) can be performed, and then the step (C) can be performed. Alternatively, after the step (C), the step (B) can be performed, and then the step (A) can be performed.

The same step can be performed twice or more. For example, the method can be carried out in the order of the step (A), the step (B), the step (A), and the step (C) or can be carried out in the order of the step (B), the step (A), the step (C), the step (A), and the step (C).

In particular, a method including a process in which the step (B) is performed, next the step (A) is performed, and then the step (C) is performed produces a larger effect of improving image quality and thus is more preferred.

Step (A)

The step (A) is a step of applying an ink containing a coloring material to a recording medium. The ink can contain an aqueous medium and other components in addition to the coloring material.

Coloring Material

In the present invention, the ink is not limited to particular inks, and can be a cyan ink, a magenta ink, a yellow ink, a black ink, and other inks. The coloring materials contained in the inks can be known dyes or pigments. These coloring materials can be used singly or in combination of two or more of them.

In the present invention, the pigment can be any of the conventionally known pigments. The content (% by mass) of the pigment is preferably 0.2% by mass or more and 15.0% by mass or less and more preferably 0.6% by mass or more and 10.0% by mass or less based on the total mass of the ink.

In the present invention, the pigment is exemplified by resin-dispersion type pigments containing a resin as a dispersant and self-dispersion type pigments (self-dispersible pigment) in which hydrophilic groups are introduced onto the surface of pigment particles, which are classified in terms of dispersion manner. Examples of the resin-dispersion type pigment include resin dispersed pigments containing a resin dispersant, microcapsule pigments in which the surface of pigment particles is covered with a resin, and resin-bonded pigments in which an organic group containing a resin is chemically bonded to the surface of pigment particles. Pigments with different dispersion manners can naturally be used in combination. Carbon black or an organic pigment is preferably used as the specific pigment. These pigments can be used singly or in combination of two or more of them.

When the pigment used in the ink is the resin-dispersion type pigment, a resin is used as a dispersant. The resin used as the dispersant preferably has both a hydrophilic moiety and a hydrophobic moiety. Specific examples of the resin include acrylic resins prepared by polymerization of a monomer having a carboxy group, such as acrylic acid and methacrylic acid; and urethane resins prepared by polymerization of a diol having an anionic group, such as dimethylolpropionic acid.

The resin used as the dispersant preferably has an acid value of 40 mg KOH/g or more and 500 mg KOH/g or less. The resin used as the dispersant preferably has a weight average molecular weight (Mw) of 1,000 or more and 50,000 or less that is determined by GPC in terms of polystyrene.

The content (% by mass) of the resin dispersant in the ink is preferably 0.1% by mass or more and 10.0% by mass or less and more preferably 0.2% by mass or more and 4.0% by mass or less based on the total mass of the ink. The mass ratio of the content (% by mass) of the resin dispersant to the content (% by mass) of the pigment is preferably 0.1 times or more and 3.0 times or less.

The dye used in the present invention is exemplified by dyes having hues such as black, cyan, magenta, and yellow. The dye may be any of the acid dyes, the direct dyes, the basic dyes, and the disperse dyes described in the COLOUR INDEX. The content (% by mass) of the dye is preferably 1% by mass or more and 20% by mass or less and more preferably 2% by mass or more and 12% by mass or less based on the total mass of the ink.

Aqueous Medium

The ink used in the present invention can contain an aqueous medium that is water or a mixed solvent of water and a water-soluble organic solvent. The content (% by mass) of the water-soluble organic solvent is preferably 3.0% by mass or more and 50.0% by mass or less based on the total mass of the ink. As the water-soluble organic solvent, any of the conventionally, generally used water-soluble organic solvents can be used. Examples of the water-soluble organic solvent include alcohols, glycols, alkylene glycols having an alkylene group with 2 to 6 carbon atoms, polyethylene glycols, nitrogen-containing compounds, and sulfur-containing compounds. These water-soluble organic solvents can be used singly or in combination of two or more of them, as necessary. As the water, a deionized water (ion-exchanged water) is preferably used. The content (% by mass) of the water is preferably 50.0% by mass or more and 95.0% by mass or less based on the total mass of the ink.

Other Components

The ink used in the present invention can contain various component, as necessary, in addition to the above-mentioned components. The ink can contain resin particles, for example. As the resin particles, the resin particles that will be described regarding the clear ink can be used.

The ink can also contain water-soluble organic compounds that are solid at normal temperature, including polyhydric alcohols such as trimethylolpropane and trimethylolethane and urea derivatives such as urea and ethylene urea as additives. The ink can further contain various additives such as nonionic water-soluble resins, cationic water-soluble resins, surfactants, pH adjusters, anticorrosives, antiseptic agents, antifungal agents, antioxidants, reduction inhibitors, evaporation accelerators, chelating agents, and resins other than the above resin particles as additives.

Application Method

In the present invention, the method of applying the ink and the clear ink to a recording medium is preferably an ink jet recording method including a step of ejecting an ink from an ink jet recording head in response to recording signals to perform recording on a recording medium. Particularly preferred is an ink jet recording method in which thermal energy is applied to an ink and the ink is ejected from an ejection orifice of a recording head. The “recording” in the present invention includes recording on permeable recording media such as glossy paper and plain paper and recording on non-permeable recording media such as glass plates, plastic plates, and plastic films.

Step (B)

The step (B) is a step of applying a liquid composition that causes viscosity increase when mixed with the ink to the recording medium so as to at least partially overlap with an area where the ink is applied. The liquid composition can contain a reactant, an aqueous medium, and other components.

The liquid composition used in the present invention is a composition that causes viscosity increase when mixed with the ink. The liquid composition used in the present invention is preferably colorless, milky white, or white so as not to affect an image recorded with the ink. On this account, the ratio of a maximum absorbance to a minimum absorbance (maximum absorbance/minimum absorbance) is preferably 1.0 or more and 2.0 or less in a wavelength region from 400 nm to 800 nm, which is the wavelength region of visible light. This means that the liquid composition has substantially no absorbance peak in the visible light wavelength region or, if the liquid composition has a peak, the intensity of the peak is extremely small. In addition, the liquid composition used in the present invention preferably contains no coloring material. The absorbance can be determined by using an undiluted liquid composition with a Hitachi double beam spectrophotometer, U-2900 (manufactured by Hitachi High-Technologies Corporation). In the measurement, the liquid composition can be diluted and subjected to absorbance measurement. This is because both the maximum absorbance and the minimum absorbance of a liquid composition are proportional to a dilution ratio and thus the ratio of the maximum absorbance to the minimum absorbance (maximum absorbance/minimum absorbance) does not depend on a dilution ratio.

Reactant

The liquid composition used in the present invention can contain a reactant that causes viscosity increase when coming in contact with the ink. The reactant may be a conventionally known compound. Specifically, at least one substance selected from polyvalent metal ions and organic acids is preferably used. A plurality of types of reactants are also preferably contained in the liquid composition.

Specific examples of the polyvalent metal ion include divalent metal ions such as Ca²⁺, Cu²⁺, Ni²⁺, Mg²⁺, Sr²⁺, Ba²⁺, and Zn²⁺; and trivalent metal ions such as Fe³⁺, Cr³⁺, Y³⁺, and Al³⁺. In the present invention, the polyvalent metal ion can be added in a salt form such as hydroxides and chlorides, which are dissociated to form those ions. In the present invention, the content (% by mass) of the polyvalent metal ion is preferably 3% by mass or more and 90% by mass or less based on the total mass of the liquid composition.

Specific examples of the organic acid include oxalic acid, polyacrylic acid, formic acid, acetic acid, propionic acid, glycolic acid, malonic acid, malic acid, maleic acid, ascorbic acid, levulinic acid, succinic acid, glutaric acid, glutamic acid, furmaric acid, citric acid, tartaric acid, lactic acid, pyrrolidonecarboxylic acid, pyronecarboxylic acid, pyrrolecarboxylic acid, furancarboxylic acid, pyridinecarboxylic acid, coumaric acid, thiophenecarboxylic acid, nicotinic acid, oxysuccinic acid, and dioxysuccinic acid. In the present invention, the content (% by mass) of the organic acid is preferably 3% by mass or more and 99% by mass or less based on the total mass of the liquid composition.

Aqueous Medium

The liquid composition used in the present invention can contain an aqueous medium that is water or a mixed solvent of water and a water-soluble organic solvent. The content (% by mass) of the water-soluble organic solvent is preferably 3.0% by mass or more and 50.0% by mass or less based on the total mass of the liquid composition. As the water-soluble organic solvent, any of the conventionally, generally used water-soluble organic solvents can be used. Examples of the water-soluble organic solvent include alcohols, glycols, alkylene glycols having an alkylene group with 2 to 6 carbon atoms, polyethylene glycols, nitrogen-containing compounds, and sulfur-containing compounds. These water-soluble organic solvents can be used singly or in combination of two or more of them, as necessary. As the water, a deionized water (ion-exchanged water) is preferably used. The content (% by mass) of the water is preferably 50.0% by mass or more and 95.0% by mass or less based on the total mass of the liquid composition.

Other Components

The liquid composition used in the present invention can also contain water-soluble organic compounds that are solid at normal temperature, including polyhydric alcohols such as trimethylolpropane and trimethylolethane and urea derivatives such as urea and ethylene urea, as necessary, in addition to the above-mentioned components. The liquid composition of the present invention can further contain various additives such as surfactants, pH adjusters, anticorrosives, antiseptic agents, antifungal agents, antioxidants, reduction inhibitors, evaporation accelerators, chelating agents, and resins, as necessary.

Application Method

In the present invention, the liquid composition is applied to the recording medium so as to at least partially overlap with an area where the ink is applied. The “area where the ink is applied” includes an area where the ink has been applied and an area where the ink is not applied yet but the liquid composition is applied and then the ink is to be applied. The condition “so as to at least partially overlap” means that an area where the ink is applied partially or wholly overlaps an area where the liquid composition is applied.

In the present invention, the method of applying the liquid composition to a recording medium is exemplified by application by a coating method in addition to the application by the ink jet method described above. The coating method is exemplified by roller coating, bar coating, and spray coating.

Step (C)

The step (C) is a step of applying a clear ink containing no coloring material to the recording medium so as to at least partially overlap with an area where the liquid composition is applied. The clear ink used in the present invention contains an anionic water-soluble resin and at least one surfactant selected from fluorine-based surfactants and silicone-based surfactants.

Water-Soluble Resin

The water-soluble resin used in the present invention is an anionic water-soluble resin and has an anionic group. The anionic group is exemplified by a carboxy group (—COOH), a sulfonic acid group (—SO₃H), and a phosphoric acid group (—PO₄H). The water-soluble resin can be prepared by polymerizing a monomer having an anionic group or by performing reaction of a resin having a functional group that can be converted into an anionic group to convert the functional group into the anionic group.

The anionic monomer is not limited to particular types. As the monomer having a carboxy group, unsaturated carboxylic acids such as acrylic acid, methacrylic acid, and maleic acid can be used. As the monomer having a sulfonic acid group, styrenesulfonic acid or vinylsulfonic acid can be used, for example. As the monomer having a phosphoric acid group, vinylphosphonic acid can be used, for example. Among these monomers, the monomer having a carboxy group is preferably used. In other words, the water-soluble resin preferably has a constituent unit derived from an unsaturated carboxylic acid.

The water-soluble resin used in the present invention preferably has a hydrophobic group in combination with the anionic group. The hydrophobic group is exemplified by groups having an aromatic ring (a phenyl group or a benzyl group, for example). This is because control of the ratio between the anionic group and the hydrophobic group enables control of the reactivity between the water-soluble resin and the liquid composition. The water-soluble resin having an anionic group and a hydrophobic group can be prepared by copolymerizing a hydrophobic monomer with an anionic monomer. The hydrophobic monomer is not limited to particular types, and known hydrophobic monomers such as styrene, styrene derivatives, benzyl acrylate, and benzyl methacrylate can be used.

The water-soluble resin used in the present invention preferably has an acid value of 40 mg KOH/g or more and 500 mg KOH/g or less. The acid value is more preferably 40 mg KOH/g or more and 90 mg KOH/g or less and particularly preferably 40 mg KOH/g or more and 70 mg KOH/g or less. The water-soluble resin preferably has a weight average molecular weight of 1,000 or more and 50,000 or less. The water-soluble resin preferably has a polydispersity (ratio of weight average molecular weight Mw to number average molecular weight Mn, Mw/Mn) of 1.0 or more and 3.0 or less.

The water-soluble resin is preferably added to the ink in a salt form prepared in such a way that a pH adjuster is added to an aqueous solution of the resin prepared by polymerization of the monomer to adjust the pH of the aqueous solution to 7 to 10. Specific examples of the pH adjuster include various organic amines such as monoethanolamine, diethanolamine, and triethanolamine; and inorganic alkaline agents such as hydroxides of alkali metals, including sodium hydroxide, lithium hydroxide, and potassium hydroxide.

The content of the water-soluble resin in the clear ink is preferably 0.3% by mass or more and 40.0% by mass or less based on the total mass of the clear ink.

In the present specification, the term “water-soluble resin” means a resin having a solubility of 1 g/L or more in water at 25° C.

Surfactant

The surfactant contained in the clear ink is at least one surfactant selected from fluorine-based surfactants and silicone-based surfactants. The fluorine-based surfactants are surfactants having a fluorocarbon molecular chain in the molecular structure. The silicone-based surfactants are surfactants having an organosiloxane structure in the molecular structure. Such a surfactant has low interaction with a water-soluble resin and thus can make the water-soluble resin having reacted with the liquid composition immediately aggregate. In addition, such a surfactant is readily incorporated in aggregates formed by aggregation of the water-soluble resin that has come in contact with the liquid composition and thus can effectively suppress image shifts. Specific examples of these surfactants include those available under the following trade names: Zonyl FSO-100 (manufactured by DuPont), Capstone FS-3100 (manufactured by DuPont), MEGAFACE F-444 (manufactured by DIC), BYK-349 (manufactured by BYK Chemie), BYK-333 (manufactured by BYK Chemie), and BYK-3455 (manufactured by BYK Chemie).

The surfactant is preferably a side-chain polyether-modified silicone-based surfactant represented by General Formula (1).

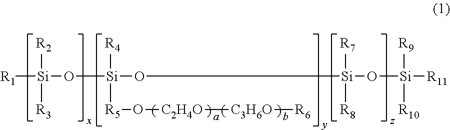

In General Formula (1), R₁ to R₄ and R₆ to R₁₁ are independently a hydrogen atom or a monovalent organic group. The monovalent organic group represented by R₁ to R₄ and R₆ to R₁₁ is preferably a hydrocarbon group and more preferably an alkyl group having a carbon number of 1 or more and 10 or less. Specific examples of the monovalent organic group include a methyl group, an ethyl group, a propyl group, an isopropyl group, a butyl group, an isobutyl group, and a hexyl group. R₅ is a divalent organic group. The divalent organic group represented by R₅ is preferably a hydrocarbon group and more preferably an alkylene group having a carbon number of 1 or more and 10 or less. Specific examples of the divalent organic group include a methylene group, an ethylene group, a propylene group, a butylene group, and a hexylene group. x, y, and a are independently an integer of 1 or more and 30 or less. x and y are preferably an integer of 1 or more and 20 or less. z and b are independently an integer of 0 or more and 30 or less. z and b are particularly preferably an integer of 0 or more and 20 or less.

The content of the surfactant in the clear ink is 1% by mass or more and 8% by mass or less and preferably 2% by mass or more and 8% by mass or less based on the total mass of the clear ink. The mass ratio of the content of the water-soluble resin to the content of the surfactant in the clear ink is 0.3 times or more and 10.0 times or less and preferably 0.5 times or more and 8 times or less. A surfactant other than the above-mentioned surfactant can be further contained in the clear ink in order to adjust the surface tension of the clear ink, for example.

Aqueous Medium

The clear ink used in the present invention can contain an aqueous medium that is water or a mixed solvent of water and a water-soluble organic solvent. The content (% by mass) of the water-soluble organic solvent is preferably 1.0% by mass or more and 50.0% by mass or less based on the total mass of the clear ink. As the water-soluble organic solvent, any of the conventionally, generally used water-soluble organic solvents can be used. Examples of the water-soluble organic solvent include alcohols, glycols, alkylene glycols having an alkylene group with 2 to 6 carbon atoms, polyethylene glycols, nitrogen-containing compounds, and sulfur-containing compounds. These water-soluble organic solvents can be used singly or in combination of two or more of them, as necessary. As the water, a deionized water (ion-exchanged water) is preferably used. The content (% by mass) of the water is preferably 30.0% by mass or more and 95.0% by mass or less based on the total mass of the clear ink.

Other Components

The clear ink used in the present invention can contain various components, as necessary, in addition to the above-mentioned components. The clear ink can contain resin particles, for example. The “resin particles” mean a resin present in a state of particles having a particle size and dispersed in a solvent. In the present invention, any resin particles can be used in the clear ink. As the monomer used for the resin particles, any of the monomers polymerizable by emulsion polymerization, suspension polymerization, dispersion polymerization, or a similar method can be used. Examples of the resin particles include acrylic resin particles, vinyl acetate resin particles, ester resin particles, ethylene resin particles, urethane resin particles, synthetic rubber particles, vinyl chloride resin particles, vinylidene chloride resin particles, and olefinic resin particles, which are classified in terms of the difference in monomer. Among them, acrylic resin particles or urethane resin particles are preferably used. In the present invention, the resin particles are preferably anionic resin particles.

Examples of the monomer specifically usable for the acrylic resin particles include α,β-unsaturated carboxylic acid such as (meth)acrylic acid, maleic acid, crotonic acid, angelic acid, itaconic acid, and fumaric acid and salts thereof; ester compounds of α,β-unsaturated carboxylic acids, such as ethyl (meth)acrylate, methyl (meth)acrylate, butyl (meth)acrylate, methoxyethyl (meth)acrylate, ethoxyethyl (meth)acrylate, diethylene glycol (meth)acrylate, triethylene glycol (meth)acrylate, tetraethylene glycol (meth)acrylate, polyethylene glycol (meth)acrylate, methoxydiethylene glycol (meth)acrylate, methoxytriethylene glycol (meth)acrylate, methoxytetraethylene glycol (meth)acrylate, methoxypolyethylene glycol (meth)acrylate, cyclohexyl (meth)acrylate, isobornyl (meth)acrylate, N,N-dimethylaminopropyl (meth)acrylate, monobutyl maleate, and dimethyl itaconate; alkyl amide compounds of α,β-unsaturated carboxylic acids such as (meth)acrylamide, dimethyl(meth)acrylamide, N,N-dimethylethyl(meth)acrylamide, N,N-dimethylpropyl(meth)acrylamide, isopropyl(meth)acrylamide, diethyl(meth)acrylamide, (meth)acryloylmorpholine, maleic acid monoamide, and crotonic acid methylamide; α,β-ethylenically unsaturated compounds having an aryl group, such as styrene, α-methylstyrene, vinyl phenylacetate, benzyl (meth)acrylate, and 2-phenoxyethyl (meth)acrylate; and ester compounds of polyfunctional alcohols, such as ethylene glycol diacrylate and polypropylene glycol dimethacrylate. Such an acrylic resin may be a homopolymer prepared by polymerization of a single monomer or a copolymer prepared by polymerization of two or more monomers. When the resin particles are a copolymer, the copolymer may be a random copolymer or a block copolymer. Specifically preferred are resin particles prepared by using hydrophilic monomers and hydrophobic monomers. The hydrophilic monomer is exemplified by α,β-unsaturated carboxylic acids and salts thereof, and the hydrophobic monomer is exemplified by ester compounds of α,β-unsaturated carboxylic acids and α,β-ethylenically unsaturated compounds having an aryl group.

The urethane resin particles are resin particles synthesized by reacting a polyisocyanate which is a compound having two or more isocyanate groups with a polyol compound which is a compound having two or more hydroxy groups. In the present invention, any of the urethane resin particles that are prepared by reacting a known polyisocyanate compound with a known polyol compound can be used as long as the requirements for the resin particles are satisfied.

Examples of the resin particles include resin particles having a single layer structure and resin particles having a multi-layered structure such as a core-shell structure, which are classified in terms of structure. In the present invention, resin particles having a multi-layered structure are preferably used. In particular, resin particles having a core-shell structure are more preferably used. When resin particles have a core-shell structure, the core part and the shell part function in clearly different ways. Resin particles having such a core-shell structure have an advantage of capable of imparting more functions to an ink than those by resin particles having a single layer structure.

The clear ink can also contain water-soluble organic compounds that are solid at normal temperature, including polyhydric alcohols such as trimethylolpropane and trimethylolethane and urea derivatives such as urea and ethylene urea. The clear ink used in the present invention can further contain various additives such as nonionic water-soluble resins, surfactants, pH adjusters, anticorrosives, antiseptic agents, antifungal agents, antioxidants, reduction inhibitors, evaporation accelerators, chelating agents, and resins other than the above resin particles, as necessary.

Application Method

In the present invention, the clear ink is applied to the recording medium so as to at least partially overlap with an area where the liquid composition is applied. The “area where the liquid composition is applied” includes an area where the liquid composition has been applied and an area where the liquid composition is not applied yet but the clear ink is applied and then the liquid composition is to be applied. The condition “so as to at least partially overlap” means that an area where the liquid composition is applied partially or wholly overlaps an area where the clear ink is applied. In the present invention, the clear ink is preferably applied to the recording medium so as to at least partially overlap with an area where the ink is applied.

Ink Set

The ink set of the present invention is an ink set including an ink containing a coloring material, a liquid composition that causes viscosity increase when mixed with the ink, and a clear ink containing no coloring material. The clear ink contains an anionic water-soluble resin and at least one surfactant selected from fluorine-based surfactants and silicone-based surfactants. The content of the surfactant in the clear ink is 1% by mass or more and 8% by mass or less based on the total mass of the clear ink. The mass ratio of the content of the water-soluble resin to the content of the surfactant in the clear ink is 0.3 times or more and 10.0 times or less.

In the ink set of the present invention, specific components of the ink, the liquid composition, and the clear ink and the formulation thereof are the same as those described above regarding the image recording method. The ink set of the present invention can be suitably used in the image recording method of the present invention.

### EXAMPLES

The present invention will next be described in further detail with reference to examples and comparative examples. The present invention is not intended to be limited to the following examples without departing from the gist of the invention. In the following description in examples, “part” is based on mass unless otherwise noted.

Water-Soluble Resin

As the water-soluble resins added to clear inks or inks, the aqueous water-soluble resin solutions 1 to 4 shown in Table 1 were used. The aqueous water-soluble resin solutions 1 to 5 are aqueous resin solutions prepared by neutralizing a styrene-butyl acrylate-acrylic acid copolymer with potassium hydroxide (neutralizer) and adjusting the solid content of the aqueous solution to a predetermined value. These aqueous resin solutions differ from each other, as shown in Table 1, in the acid value and the weight average molecular weight of the water-soluble resin, the solid content of the aqueous resin solution, and in terms of whether the aqueous resin solution contains 2-pyrrolidone or not. The aqueous water-soluble resin solution 5 shown in Table 1 was used to prepare the resin particle dispersion 1 described later.

TABLE 1

| | | Aqueous water-soluble | | | | |
|---|---|---|---|---|---|---|
| | | resin solution no. | | | | |
| | | 1 | 2 | 3 | 4 | 5 |
| Water-soluble | Resin type | Styrene-butyl acrylate- | | | | |
| resin | | acrylic acid copolymer | | | | |
| | Acid value [mg KOH/g] | 121 | 88 | 65 | 150 | 130 |
| | Weight average | 7,000 | 8,000 | 8,300 | 8,000 | 7,000 |
| | molecular weight | | | | | |
| Formulation of | Solid content [%] | 20 | 20 | 20 | 20 | 6 |
| aqueous solution | 2-Pyrrolidone [%] | | 20 | 20 | | |

| | |
|---|---|
| Neutralizer | Potassium hydroxide |

* Units of solid content and 2-pyrrolidone are % by mass.

Preparation of Resin Particle Dispersion

Preparation of Resin Particle Dispersion 1

As the resin particles added to clear inks and inks, the resin particle dispersion 1 shown below was used. First, 18 parts of ethyl methacrylate, 2 parts of 2,2′-azobis-(2-methylbutyronitrile), and 2 parts of n-hexadecane were mixed, and the mixture was stirred for 0.5 hour. The mixture was added dropwise to 78 parts of the aqueous water-soluble resin solution 5 shown in Table 1, and the resulting mixture was stirred for 0.5 hour. Next, the mixture was sonicated with a sonicator for 3 hours. Subsequently, the mixture was polymerized under a nitrogen atmosphere at 80° C. for 4 hours. The reaction solution was cooled to room temperature and then filtered, giving a resin particle dispersion 1 having a resin particle content of 40.0% by mass. The resin constituting the resin particles had a weight average molecular weight of 250,000, and the resin particles had an average particle diameter (Dso) of 200 nm.

Preparation of Clear Ink

Preparation of Clear Ink 1

The aqueous water-soluble resin solution 1, a surfactant 1, glycerin (GLY), polyethylene glycol (PEG) having a number average molecular weight of 1,000, and ion-exchanged water were thoroughly stirred and mixed. The mixture was subjected to pressure filtration through a microfilter with a pore size of 3.0 m (manufactured by Fujifilm), giving a clear ink 1 containing components at the ratio shown in Table 2-1. In Table 2-1 and Table 2-2, the “remainder” of ion-exchanged water is such an amount that the total amount of all the components constituting the clear ink becomes 100.0% by mass. The surfactants 1 to 6 are specifically shown in Table 3.

Preparation of Clear Inks 2 to 18

Clear inks 2 to 18 were prepared in the same manner as for the clear ink 1 except that the types and the amounts of the aqueous water-soluble resin solution (including the resin particle dispersion) and the surfactant were changed as shown in Table 2-1 and Table 2-2.

TABLE 2-1

| | Clear ink no. | | | | | | | | |
|---|---|---|---|---|---|---|---|---|---|
| | 1 | 2 | 3 | 4 | 5 | 6 | 7 | 8 | 9 |
| Aqueous water- | 25.0 | 25.0 | 25.0 | 25.0 | 25.0 | 25.0 | 10.0 | 50.0 | |
| soluble resin | | | | | | | | | |
| solution 1 | | | | | | | | | |
| Aqueous water- | | | | | | | | | 25.0 |
| soluble resin | | | | | | | | | |
| solution 2 | | | | | | | | | |
| Aqueous water- | | | | | | | | | |
| soluble resin | | | | | | | | | |
| solution 3 | | | | | | | | | |
| Resin particle | | | | | | | | | |
| dispersion | | | | | | | | | |
| Surfactant 1 | 1.0 | | | 2.0 | | | | | |
| Surfactant 2 | | 1.0 | | | | | | | |
| Surfactant 3 | | | 1.0 | | 2.0 | | 6.0 | 1.0 | 2.0 |
| Surfactant 4 | | | | | | 2.0 | | | |
| Surfactant 5 | | | | | | | | | |
| Surfactant 6 | | | | | | | | | |
| GLY | 7.0 | 7.0 | 7.0 | 7.0 | 7.0 | 7.0 | 7.0 | 7.0 | 7.0 |
| PEG | 3.0 | 3.0 | 3.0 | 3.0 | 3.0 | 3.0 | 3.0 | 3.0 | 3.0 |
| Ion-exchanged | Remainder | Remainder | Remainder | Remainder | Remainder | Remainder | Remainder | Remainder | Remainder |
| water | | | | | | | | | |
| Water-soluble | 5.0 | 5.0 | 5.0 | 2.5 | 2.5 | 2.5 | 0.33 | 10.0 | 2.5 |
| resin/surfactant | | | | | | | | | |

* Water-soluble resin/surfactant is expressed in terms of mass ratio. The units of the other numerical values are % by mass.

TABLE 2-2

| | Clear ink no. | | | | | | | | |
|---|---|---|---|---|---|---|---|---|---|
| | 10 | 11 | 12 | 13 | 14 | 15 | 16 | 17 | 18 |
| Aqueous water- | 25.0 | 25.0 | 35.0 | 60.0 | 50.0 | 5.0 | | | |
| soluble resin | | | | | | | | | |
| solution 1 | | | | | | | | | |
| Aqueous water- | | | | | | | | | |
| soluble resin | | | | | | | | | |
| solution 2 | | | | | | | | | |
| Aqueous water- | | | | | | | | 25.0 | |
| soluble resin | | | | | | | | | |
| solution 3 | | | | | | | | | |
| Aqueous water- | | | | | | | | | 25.0 |
| soluble resin | | | | | | | | | |
| solution 4 | | | | | | | | | |
| Resin particle | | | | | | | 25.0 | | |
| dispersion | | | | | | | | | |
| Surfactant 1 | | | 0.8 | 1.0 | 0.7 | 4.0 | | | |
| Surfactant 2 | | | | | | | | | |
| Surfactant 3 | | | | | | | | 2.0 | 2.0 |
| Surfactant 4 | | | | | | | | | |
| Surfactant 5 | 1.0 | | | | | | 1.0 | | |
| Surfactant 6 | | 1.0 | | | | | | | |
| GLY | 7.0 | 7.0 | 7.0 | 7.0 | 7.0 | 7.0 | 7.0 | 1.0 | 7.0 |
| PEG | 3.0 | 3.0 | 3.0 | 3.0 | 3.0 | 3.0 | 3.0 | 3.0 | 3.0 |
| Ion-exchanged | Remainder | Remainder | Remainder | Remainder | Remainder | Remainder | Remainder | Remainder | Remainder |
| water | | | | | | | | | |
| Water-soluble | 5.0 | 5.0 | 8.75 | 12.0 | 14.3 | 0.3 | — | 2.5 | 2.5 |
| resin/surfactant | | | | | | | | | |

* Water-soluble resin/surfactant is expressed in terms of mass ratio. The units of the other numerical values are % by mass.

TABLE 3

| | Trade name | Supplier | Classification |
|---|---|---|---|
| Surfactant 1 | MEGAFACE | DIC | Fluorine-based |
| | F 444 | | |
| Surfactant 2 | Capstone | DuPont | Fluorine-based |
| | FS-3100 | | |
| Surfactant 3 | BYK3455 | BYK Chemie | Side-chain-modified |
| | | | silicone-based |
| Surfactant 4 | BYK333 | BYK Chemie | Both-end-modified |
| | | | silicone-based |
| Surfactant 5 | Acetylenol | Kawaken Fine | Acetylene glycol- |
| | E100 | Chemicals | based |
| Surfactant 6 | BC20 | Nikko | Alkyl ether-based |
| | | Chemicals | |

Preparation of Pigment Dispersion

Preparation of Black Pigment Dispersion

First, 10 parts of carbon black (product name: Monarch 1100, manufactured by Cabot), 15 parts of the aqueous water-soluble resin solution 4, and 75 parts of ion-exchanged water were mixed. The mixture was placed in a batch type vertical sand mill (manufactured by Aimex), and then 200 parts of 0.3-mm zirconia beads were placed. The mixture was dispersed for 5 hours while being cooled with water. The dispersion was centrifuged to remove coarse particles, giving a black pigment dispersion having a pigment content of 10.0% by mass.

Preparation of Cyan Pigment Dispersion and Magenta Pigment Dispersion

A cyan pigment dispersion and a magenta pigment dispersion each having a pigment content of 10.0% were prepared in the same manner as for the black pigment dispersion except that the pigment type was changed as shown in Table 4.

TABLE 4

| | Bk pigment | C pigment | M pigment |
|---|---|---|---|
| Pigment dispersion | dispersion | dispersion | dispersion |
| Carbon black | 10.0 | | |
| C.I. Pigment Blue 15:3 | | 10.0 | |
| C.I. Pigment Red 122 | | | 10.0 |
| Aqueous water-soluble | 15.0 | 15.0 | 15.0 |
| resin solution 4 | | | |
| Ion-exchanged water | 75.0 | 75.0 | 75.0 |

* The units of all the numerical values are % by mass.

Preparation of Ink

Preparation of Black Ink

The black pigment dispersion, the resin particle dispersion, glycerin (GLY), polyethylene glycol (PEG) having a number average molecular weight of 1,000, and ion-exchanged water were thoroughly stirred and mixed. The mixture was subjected to pressure filtration through a microfilter with a pore size of 3.0 μm (manufactured by Fujifilm), giving a black ink containing components at the ratio shown in Table 5. In Table 5, the “remainder” of ion-exchanged water is such an amount that the total amount of all the components constituting the ink becomes 100.0% by mass.

Preparation of Cyan Ink and Magenta Ink

Each of a cyan ink and a magenta ink was prepared in the same manner as for the black ink except that the pigment dispersion type was changed as shown in Table 5.

TABLE 5

| Ink | Bk ink | C ink | M ink |
|---|---|---|---|
| Bk pigment dispersion | 40.0 | | |
| C pigment dispersion | | 40.0 | |
| M pigment dispersion | | | 40.0 |
| Resin particle dispersion | 12.5 | 12.5 | 12.5 |
| GLY | 7.0 | 7.0 | 7.0 |
| PEG | 3.0 | 3.0 | 3.0 |
| Acetylenol E-100 | 1.0 | 1.0 | 1.0 |
| Ion-exchanged water | Remainder | Remainder | Remainder |

* The units of all the numerical values are % by mass.

Preparation of Liquid Composition

Preparation of Liquid Composition 1

Glutaric acid, glycerin (GLY), a surfactant (Acetylenol E-100), and ion-exchanged water were thoroughly stirred and mixed. The mixture was subjected to pressure filtration through a microfilter with a pore size of 3.0 m (manufactured by Fujifilm), giving a liquid composition 1 containing components at the ratio shown in Table 6.

Preparation of Liquid Composition 2

A liquid composition 2 was prepared in the same manner as for the liquid composition 1 except that the types and the amounts of the reactants were changed as shown in Table 6.

TABLE 6

| Liquid composition | 1 | 2 |
|---|---|---|
| Glutaric acid | 30.0 | |
| Potassium hydroxide | 5.0 | |
| Calcium nitrate tetrahydrate | | 30.0 |
| GLY | 5.0 | 5.0 |
| Acetylenol E-100 | 1.0 | 1.0 |
| Ion-exchanged water | 59.0 | 64.0 |

* The units of all the numerical values are % by mass.

Recording Medium

As the recording medium, a pearl coated paper and an intermediate transfer member were prepared. As the pearl coated paper, Pearl Coat manufactured by Mitsubishi Paper Mills was used. As the intermediate transfer member, an intermediate transfer member used for transfer ink jet recording was prepared. The intermediate transfer member is such that an image is once formed on a non-permeable medium and then the image is transferred to a coated paper, and has a two-layer structure including a supporting member and a surface layer member. As the supporting member, a flat plate made of an aluminum alloy was used. As the surface layer member, a hydrolyzable organic silicon compound was used as a raw material, and a siloxane compound was used to form a surface layer on the surface of the supporting member.

Evaluation of Image

The inks and the liquid compositions obtained in the above were filled in ink cartridges, which were combined as shown in Table 7 and installed in an image recorder. First, the liquid composition obtained in the above was applied to a recording medium in a coating amount of 1.0 g/m² with a coating roller. To the recording medium coated with the liquid composition, the ink was then ejected from an ink jet recording head, and the resulting image was evaluated. Here, the liquid composition 2 was used only in Example 10, and the liquid composition 1 was used in the other examples. The liquid composition was applied from an ink jet recording head at 50% duty only in Example 11, and a coating roller was used in the other examples. The intermediate transfer member was used as the recording medium only in Example 12, and coated paper (pearl coated paper) was used in the other examples.

For the image recorder, the condition in which 3.0 nanograms (ng) of an ink drop was applied to a unit area of 1/1,200 inch× 1/1,200 inch at a resolution of 1,200 dpi×1,200 dpi is defined as a recording duty of 100%.

To the recording medium coated with the liquid composition, the cyan ink, the magenta ink, and the black ink were applied from the ink jet recording head to form a 100%-duty solid image on an area of 5 cm×5 cm, a 200%-duty solid image on an area of 5 cm×5 cm, and a 300%-duty solid image on an area of 5 cm×5 cm. The clear ink was further ejected at 200% duty onto the image formed with the inks, giving an image for evaluation.

The evaluation results of smeared images, image cracks, and gloss are shown in Table 7.

Evaluation of Smeared Image

AA: An excellent image with no smeared image

A: A good image with almost no smeared image

B: A partially smeared but usable image

C: A markedly smeared and unusable image

Evaluation of Image Crack

Solid image conditions were observed under a microscope and evaluated.

AA: An excellent solid image with no image crack was recorded.

A: The area proportion of the image cracked part was not less than 1% and less than 5%, and a good solid image was recorded.

B: The area proportion of the image cracked part was not less than 5% and less than 10%, and an acceptable solid image was recorded while a color skip area was partially observed.

C: Image cracks were observed, and no solid image was able to be recorded.

Evaluation of Gloss

A: A good image without gloss unevenness

B: A usable image with some gloss unevenness

C: An unusable image with marked gloss unevenness

TABLE 7

| | Combination | | Liquid | | | | |
|---|---|---|---|---|---|---|---|
| | Clear | Liquid | composition | | Evaluation | | |
| | ink | composition | application | Recording | | Image | Smeared |
| | no. | no. | means | medium | Gloss | crack | image |
| Example 1 | Clear | Liquid | Roller | Coated paper | A | B | A |
| | ink 1 | composition 1 | | | | | |
| Example 2 | Clear | Liquid | Roller | Coated paper | A | B | A |
| | ink 2 | composition 1 | | | | | |
| Example 3 | Clear | Liquid | Roller | Coated paper | A | B | A |
| | ink 3 | composition 1 | | | | | |
| Example 4 | Clear | Liquid | Roller | Coated paper | A | A | A |
| | ink 4 | composition 1 | | | | | |
| Example 5 | Clear | Liquid | Roller | Coated paper | A | AA | A |
| | ink 5 | composition 1 | | | | | |
| Example 6 | Clear | Liquid | Roller | Coated paper | A | A | A |
| | ink 6 | composition 1 | | | | | |
| Example 7 | Clear | Liquid | Roller | Coated paper | A | AA | A |
| | ink 7 | composition 1 | | | | | |
| Example 8 | Clear | Liquid | Roller | Coated paper | A | A | A |
| | ink 8 | composition 1 | | | | | |
| Example 9 | Clear | Liquid | Roller | Coated paper | A | AA | AA |
| | ink 9 | composition 1 | | | | | |
| Example 10 | Clear | Liquid | Roller | Coated paper | A | A | B |
| | ink 5 | composition 2 | | | | | |
| Example 11 | Clear | Liquid | Recording | Coated paper | A | AA | A |
| | ink 5 | composition 1 | head | | | | |
| Example 12 | Clear | Liquid | Roller | Intermediate | A | AA | A |
| | ink 5 | composition 1 | | transfer | | | |
| | | | | member | | | |
| Example 13 | Clear | Liquid | Roller | Coated paper | A | AA | AA |
| | ink 17 | composition 1 | | | | | |
| Example 14 | Clear | Liquid | Roller | Coated paper | A | AA | A |
| | ink 18 | composition 1 | | | | | |
| Comparative | Clear | Liquid | Roller | Coated paper | C | C | A |
| Example 1 | ink 10 | composition 1 | | | | | |
| Comparative | Clear | Liquid | Roller | Coated paper | A | A | C |
| Example 2 | ink 11 | composition 1 | | | | | |
| Comparative | Clear | Liquid | Roller | Coated paper | C | C | A |
| Example 3 | ink 12 | composition 1 | | | | | |
| Comparative | Clear | Liquid | Roller | Coated paper | C | C | A |
| Example 4 | ink 13 | composition 1 | | | | | |
| Comparative | Clear | Liquid | Roller | Coated paper | C | C | A |
| Example 5 | ink 14 | composition 1 | | | | | |
| Comparative | Clear | Liquid | Roller | Coated paper | A | A | C |
| Example 6 | ink 15 | composition 1 | | | | | |
| Comparative | Clear | Liquid | Roller | Coated paper | B | AA | C |
| Example 7 | ink 16 | composition 1 | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-188876, filed Sep. 17, 2014, which is hereby incorporated by reference herein in its entirety.

What is claimed is:

1. An image recording method comprising:
a step (A) of applying an ink containing a coloring material to a recording medium;
a step (B) of applying a liquid composition to the recording medium so as to at least partially overlap with an area where the ink is applied, the liquid composition causing viscosity increase when mixed with the ink; and
a step (C) of applying a clear ink containing no coloring material to the recording medium so as to at least partially overlap with an area where the liquid composition is applied,
wherein the clear ink contains an anionic water-soluble resin and at least one surfactant selected from fluorine-based surfactants and silicone-based surfactants,
wherein a content of the surfactant in the clear ink is 1% by mass or more and 8% by mass or less based on a total mass of the clear ink, and
wherein a mass ratio of a content of the water-soluble resin to the content of the surfactant in the clear ink is 0.3 times or more and 10.0 times or less.

2. The image recording method according to claim 1, wherein the content of the surfactant in the clear ink is 2% by mass or more and 8% by mass or less based on the total mass of the clear ink.

3. The image recording method according to claim 1, wherein the surfactant is a compound represented by General Formula (1): 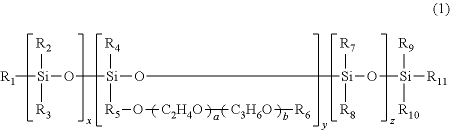
wherein in General Formula (1), R₁ to R₄ and R₆ to R₁₁ are independently a hydrogen atom or a monovalent organic group; R₅ is a divalent organic group; x, y, and a are independently an integer of 1 or more and 30 or less; and z and b are independently an integer of 0 or more and 30 or less.

4. The image recording method according to claim 1, wherein the water-soluble resin has a constituent unit derived from an unsaturated carboxylic acid and has an acid value of 40 mg KOH/g or more and 90 mg KOH/g or less.

5. An ink set comprising:
an ink containing a coloring material;
a liquid composition causing viscosity increase when mixed with the ink; and
a clear ink containing no coloring material,
wherein the clear ink contains an anionic water-soluble resin and at least one surfactant selected from fluorine-based surfactants and silicone-based surfactants,
wherein a content of the surfactant in the clear ink is 1% by mass or more and 8% by mass or less based on a total mass of the clear ink, and
wherein a mass ratio of a content of the water-soluble resin in the clear ink to the content of the surfactant in the clear ink is 0.3 times or more and 10.0 times or less.
